(19) United States
(12) Patent Application Publication
(10) Pub. No.: US 2019/0186156 A1
(43) Pub. Date: Jun. 20, 2019

(54) SKIRTING AND ARCHITRAVE INSTALLATION SYSTEM

(71) Applicant: Inter-Join Pty Ltd., Willawood, New South Wales (AU)

(72) Inventor: Tomo BERTOVIC, Willawood, New South Wales (AU)

(21) Appl. No.: 16/314,674

(22) PCT Filed: Apr. 3, 2017
(86) PCT No.: PCT/AU17/00086

§ 371 Date: Jan. 1, 2019

(30) Foreign Application Priority Data
Apr. 1, 2016 (AU) 2016100362

(51) Int. Cl. E04F 19/04

(52) U.S. Cl. CPC E04F 19/0486; F16B 5/0614; E04F 19/0481

(57) ABSTRACT

A connector piece to cover the gap between two skirting profiles disposed at an angle to each other includes a body having a bend to correspond to the angle. The body has a front portion, a rear portion, and a cavity between the front portion and the rear portion. The cavity has end portions for receiving respective end sections of the skirting profiles. The front portion forms the exposed decorative contour of the connector piece. The rear portion includes an engagement device for a respective rear surface of the skirting profiles when the end sections of the skirting profiles are received into the cavity.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to the installation of skirting and architraves and in particular to a skirting and architrave installation system that eliminates the need for skilled tradesmen to perform the work.

The invention has been developed primarily for the carpentry and building industries and will be described hereinafter with reference to these applications.

The disclosure of Australian patent application number 2013200949 FASTENER and PCT/AU2016/000186 are incorporated herein by reference. Patent application number 2013200949 has been invented to secure pre-finished skirting and architraves to the building without penetrating the pre-finished surface.

### 2. Description of Related Art Including Information Disclosed Under 37 CFR 1.97 and 37 CFR 1.98

Skirting boards and architraves are used as decorative items that frame the junction of wall and floor, and provide a frame around windows and doors. In order to achieve a neat and tidy finish, skilled tradesmen are required to accurately cut and skillfully install these decorative items. However, this method of installation is time consuming as there is no margin for error.

Furthermore, skirting and architraves are installed via nails or screws, therefore a painter is required to patch the nail/screw holes prior to applying a finishing coat of paint, which in order to achieve a high quality finish, is also time consuming and expensive.

In recent years pre-finished skirting and architraves have been available however installation is more time consuming and difficult due to inefficient installation solutions offered.

Corner moulds and covers have been offered as an alternative to cutting of mitre joints, however cutting accurate lengths is still required as the skirting and architraves essentially but up to the corner moulds.

There is thus a need for a skirting and architrave installation system that eliminates the need for skilled tradesmen, thereby reducing installation time and associated costs. This will allow the use pre-finished skirting and architraves to be used, with further finishing work not being required.

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### BRIEF SUMMARY OF THE INVENTION

According to a first aspect, the present invention provides a connector piece to cover the gap between two skirting profiles disposed at an angle to each other, the connector piece comprising:
a body having a bend to correspond to the angle, the body having a front portion, a rear portion, and a cavity between the front portion and the rear portion, the cavity having end portions for receiving respective end sections of the skirting profiles,
wherein the front portion forms the exposed decorative contour of the connector piece, and
wherein the rear portion comprises an engagement means for engaging a respective rear surface of the skirting profiles when the end sections of the skirting profiles are received into the cavity

Preferably, the connector piece is for a corner and the front portion comprises a substantially 90° bend therein corresponding to the corner of the wall.

Preferably, the corner is an internal corner or an external corner.

Preferably, the front portion matches an exposed decorative contour of the skirting profiles.

Preferably, the front portion extends from the floor when mounted in use.

Preferably, the engagement means of the rear portion comprises an inserting tab which extends downwardly from the front portion.

Preferably, the inserting tab has a bend and follows the shape of the front portion.

Preferably, the inserting tab comprises a curved lead at its lower end portion that are biased towards a rear face of the skirting profiles.

Preferably, the front portion extends from the floor in use and tightly matches the exposed decorative contour of the skirting profiles.

Preferably, the connector piece comprises strengthening ribs between the front portion and the rear portion.

Preferably, the side extremities of the front portion are wider than the side extremities of the rear portion.

Preferably, side leading edges of the front portion are splayed inwardly to contact front faces of the skirting profiles in use.

Preferably, the rear portion extends to a mid-portion of the front portion.

Preferably, the front portion has front face sections facing in perpendicular directions towards or away from each other.

The present invention also provides a skirting profile comprising a front face and a rear face, wherein the rear face in cross-section comprises upper and lower notches which engage a wall in use, the notches spacing the rear face from the wall providing a rebate between the rear face and the wall.

Preferably, the rebate is at least 3 mm in depth.

Preferably, the skirting profile comprises a top face and a bottom face and the rebate extends from adjacent a top face to adjacent the rear face.

The present invention also provides an assembly comprising two skirting profiles and the connector piece of claim 1.

The present invention also provides an architrave connector block having a top face and side walls, wherein at least two side walls comprise rebates shaped to correspond to architrave profiles.

Preferably, the block comprises a raised decorative feature extending from the top face.

Other aspects of the invention are also disclosed.

### BRIEF DESCRIPTION OF THE SEVERAL VIEWS OF THE DRAWINGS

Notwithstanding any other forms which may fall within the scope of the present invention, preferred embodiments of the present invention will now be described, by way of examples only, with reference to the accompanying drawings.

FIG. 1 shows a side cross-sectional view of a skirting profile with an increased rebate mounted against a wall.

FIG. 2 shows a side cross-sectional view of the skirting profile of FIG. 1, with its top notch removed.

FIG. 3 shows a schematic view of a skirting connector piece in position above the skirting profile.

FIG. 4 shows a schematic view of the skirting connector piece partly engaged with the skirting profile.

FIG. 5 shows a schematic view of the skirting connector piece completely engaged with the skirting profile.

FIG. 6 is an enlarged schematic view of the inserting tabs of the skirting connector piece showing flexing of the tabs.

FIG. 7 shows a plan sectional view of an external skirting connector.

FIG. 8 shows a top plan view of the external skiting connector.

FIG. 9 shows an end elevation view of the external skirting connector.

FIG. 10 shows an isometric view of the external skirting connector of FIGS. 7, 8, and 9.

FIG. 11 shows a plan sectional view of an internal skirting connector.

FIG. 12 shows a top plan view of an internal skirting connector.

FIG. 13 shows an end elevation view of the internal skirting connector.

FIG. 14 shows an isometric view of the internal skirting connector of FIGS. 11, 12, and 13.

FIG. 15. Shows an exploded isometric view of an example assembly mounted against a wall comprising cut skirting sections joined by the connector pieces above.

FIG. 16 shows an isometric view of the FIG. 15 assembly with connector pieces fitted.

FIG. 17 shows a top plan view an architrave connector block.

FIG. 18 shows an end elevation view of the architrave connector block.

FIG. 19 shows an isometric view of the architrave connector block.

FIG. 20 shows a schematic view of architrave profiles cut square, with an outline of the architrave connector block.

FIG. 21 shows a schematic view of the architrave connector block fitting over the architrave profiles.

FIG. 22 shows an isometric view of FIG. 20.

FIG. 23 shows an isometric view of FIG. 21.

### DETAILED DESCRIPTION OF THE INVENTION

It should be noted in the following description that like or the same reference numerals in different embodiments denote the same or similar features.

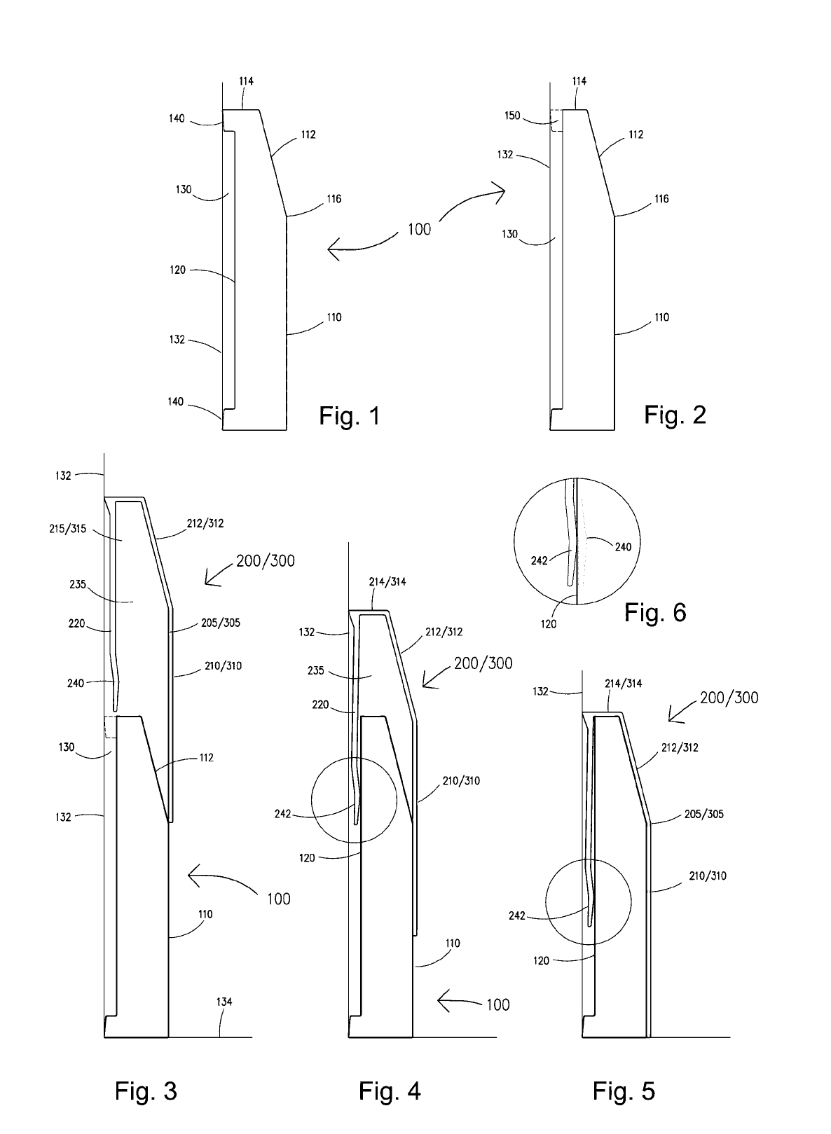

FIG. 1 shows a cross-section of a skirting profile 100 in accordance with a preferred embodiment of the present invention. The skirting profile 100 comprises a front face 110, a top face 114 and a feature splay 112 that extends between the front face 110 and the top face 114, which together form the exposed decorative contour 1 16 of the skirting profile 100. A rear face 120 of the skirting profile 110 comprises upper and lower notches 140 which meet/engage the wall 132 in use. The notches 140 space the rear face 120 from the wall providing a rebate 130, being a gap between the rear face 120 and the wall.

FIG. 2 shows the skirting profile 100 with the upper notch 140 removed (indicated as 150) from adjacent the top face 114 to form an opening to the rebate 130.

FIG. 3 shows the skirting profile 100 at the junction of the wall 132 and floor 134 with connector piece 200/300 above, meeting with the skirting face 110. The connector piece 200/300 is either an external corner connector piece 200 or internal corner connector piece 300 as further described below.

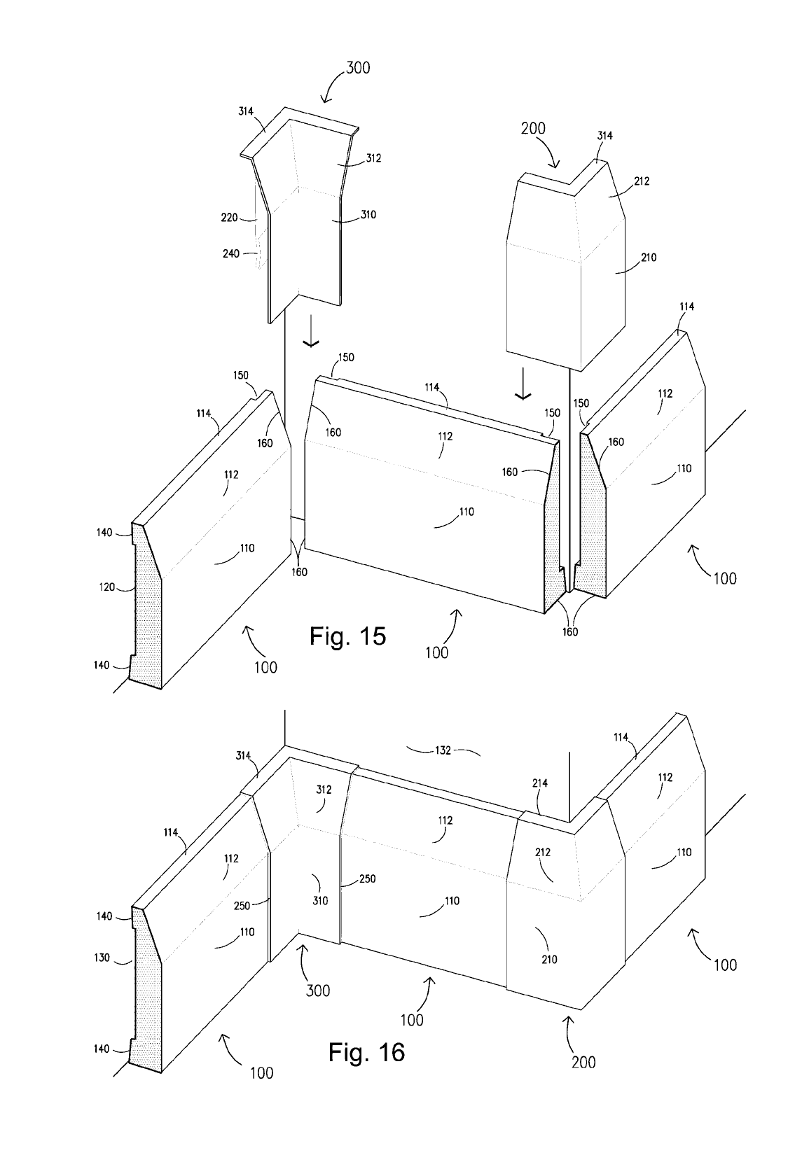

In use, the skirting profiles 100 are disposed at the junction between the wall 132 and the floor 134. As shown in FIGS. 15 and 16, the connector pieces 200/300 are shaped to extend and cover the gap between skirting profiles 100 that are disposed substantially at 90° to each other. That is, skirting profiles 100 at internal and external corners of the wall. The connector pieces 200/300 are thus shaped to have a generally right angle shaped body.

Each connector piece 200/300 comprises a front portion 205/305 and a rear portion 215/315. The front portion 205/305 comprises a front face 210/310, an ornamental/decorative splay 212/312, and a top face 214/314 which together form the exposed decorative contour of the connector piece 200/300, and which matches the exposed decorative contour 116 of the skirting profile 100. The front portion 205/305 comprises a substantially 90° angle/bend therein corresponding to the corner of the wall.

The rear portion 215/315 comprises an inserting tab 220/320 which extends downwardly from the top face 214/314. The inserting tab 220 follows the shape of the front portion 205/305 and comprises a substantially 90° angle/bend therein corresponding to the corner of the wall. In end view, the inserting tab 220 comprises a curved lead 240 at its lower end portion that is slightly proud of the rebate 130. That is, the curved lead 240 is biased towards the rear face 120.

A cavity 235 is formed between the front portion 205/305 and the rear portion 215/315 which receives an end section of the skirting profile 100 in use. The inserting tab 220 is inserted and received in the rebate 130.

FIG. 4 shows an end portion of a connector piece 200/300 partly engaged over the skirting profile 100 with front face of connector piece 210/310 fitting adjacent to the front face 110 of the skirting profile 100. As the connector piece 200/300 is inserted from above, the inserting tab 220 flexes as the curved lead 242 is pressed against the rear face 120 of the skirting profile 100.

FIG. 5 shows the connector piece 200/300 being fully installed over the skirting profile end section. The front portion 205/305 extends from the floor 134 and covers and tightly matches the exposed decorative contour of the skirting profile 100. The pressure of the flexing of the inserting tab 242 provides positive engagement to hold the connector piece 200/300 tightly against the rear face 120 of the skirting profile.

FIG. 6 shows an enlarged detail of the curved lead inserting tab being in a natural state 240 (shown via dashed lines) and flexing 242 against the rebate 120.

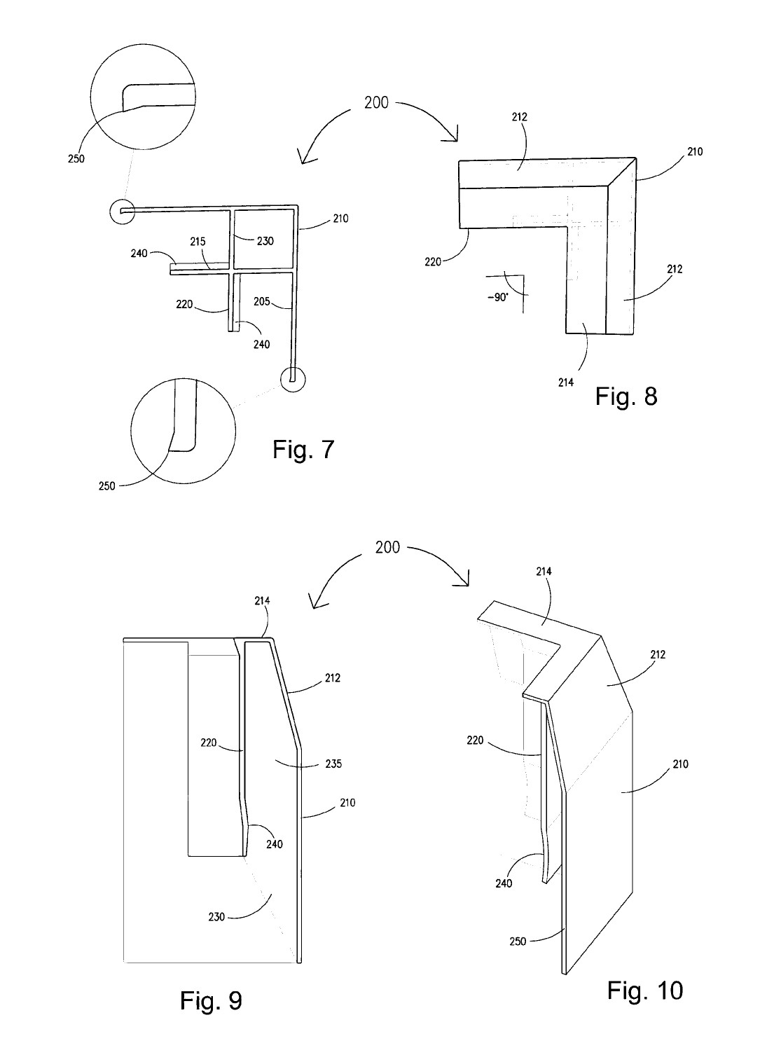

FIGS. 7 to 10 show the external corner connector piece 200.

FIG. 7 shows a top sectional view of the external corner connector piece 200, having strengthening ribs 230 between the front portion 205 and the rear portion 215. The inserting tabs 220 have the curved lead 240 for easier inserting into the rebate. The extremities of the front face 210 are wider than the edges of the rear portion 215, and contain leading edges 250 that are splayed inwardly to ensure the front face 210 of the connector piece is always in contact with the front face of the skirting profile 1 10 in use.

FIG. 8 is an overhead view of the external corner connector piece 200 having the front face 210, the ornamental/decorative splay 212, and the top face 214. The angle of the corner of the front portion 205 is less than 90 degrees to accommodate walls that are not truly square. The front portion 205 has front face sections 210 facing in perpendicular directions away from each other.

FIG. 9 is an end view of the external corner connector piece 200 showing the inserting tab 220 with a curved lead 240. The front face 210 and ornamental/decorative profile 212 are compatible to the profile of skirting 100. The reinforcing rib 230 provides strength to the external corner connector piece 200. The front portion 205 is dimensioned to cover the entire end section of the skirting profile 100 in use from the floor 134. The rear portion 215 extends to a mid-portion of the rear face 120 of the skirting profile 100.

FIG. 10 is an isometric view of the external corner connector piece 200 having the front face 210, the ornamental/decorative face 212, top face 214 and the leading edge 250. Inserting tabs 220 incorporate a curved lead 240.

FIGS. 11 to 14 show the internal corner connector piece 300, which is similarly formed as the external corner connector piece 200. The internal corner connector piece 300 however has a front portion 305 with front face sections 310 facing in perpendicular directions towards each other.

FIG. 11 shows a top sectional view of the internal corner connector piece 300, having strengthening rib 230. The inserting tabs 220 have a curved lead 240 for easier inserting into the rebate. The extremities of the front face 310 contain leading edges 250 that are splayed to ensure the front face 310 of the connector piece is always in contact with the front face of the skirting profile 110.

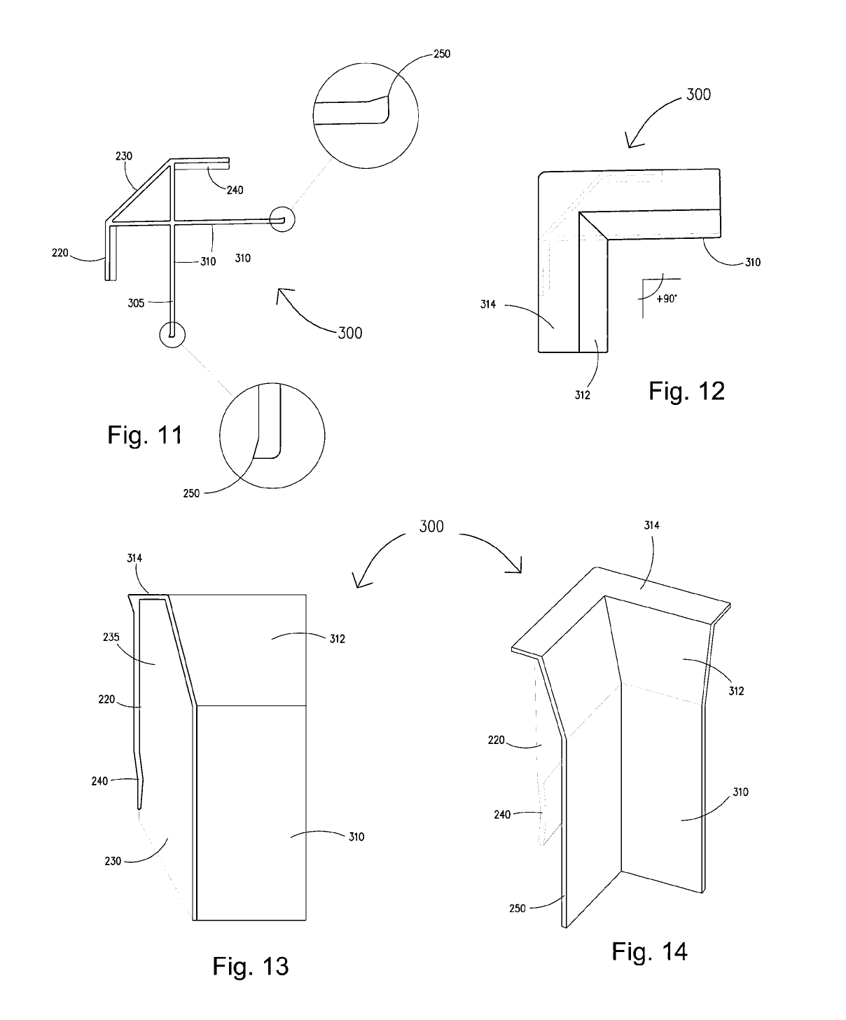

FIG. 12 is an overhead view of the internal corner connector piece 300 having a front face 310 an ornamental/decorative splay 312, and a top face 314. The angle of the corner is more than 90 degrees to accommodate walls that are not truly square.

FIG. 13 is an end view of the internal corner connector piece showing the rear inserting tab 220 with a curved lead 240. The front face 310 and ornamental/decorative profile 312 are compatible to the profile of skirting 100. The reinforcing rib 230 provides strength to the external corner connector piece 300.

FIG. 14 is an isometric view of the internal corner connector piece 300 having a front face 310, an ornamental/decorative face 312, top face 314 and a leading edge 250. Inserting tabs 220 incorporate a curved lead 240.

FIG. 15 shows an isometric view of an example assembly with an internal and external corner. The assembly comprises skirting 100 with cutting 160 that are not required to be accurate. At the top face 114, the end sections are notched 150 to expose the rebate 130 for insertion of the inserting tabs 220 of the connector pieces 200/300. The connector pieces 200/300 are inserted from above with the inserting tabs 220 and curved lead 240 providing a tight pressed fit against the front portion of the skirting profile 100.

FIG. 16 shows an isometric view of installed skirting 100 with connector pieces 200/300 corresponding to the profile of the skirting. The profiles 210/310 tightly fit against the front face 110 of the skirting profile 100 via leading edges 250 of the connector pieces 200/300.

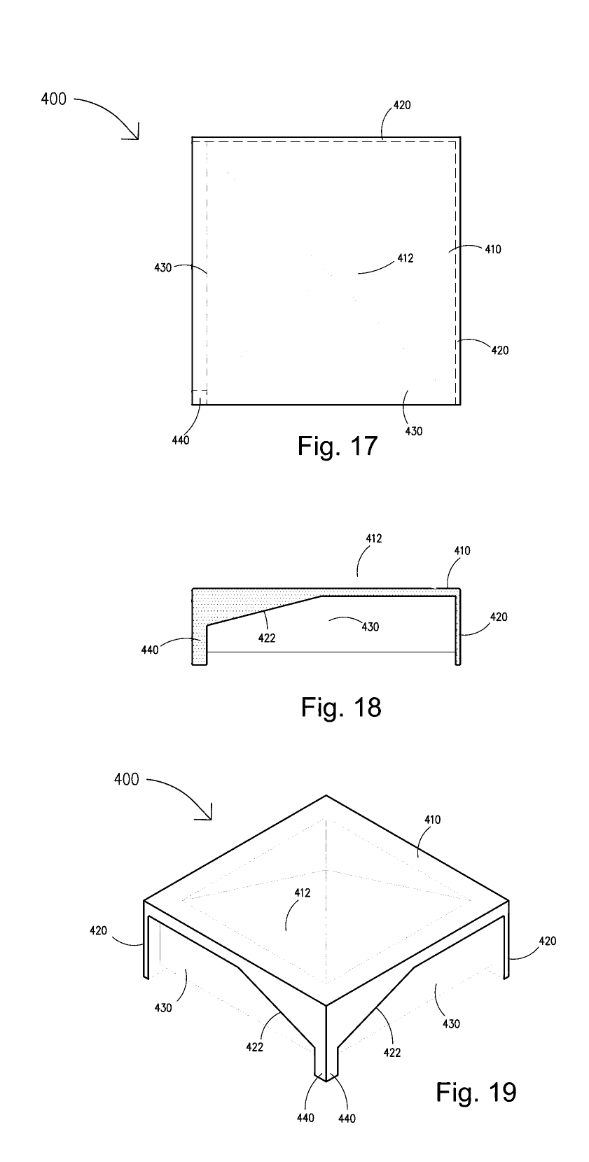

FIGS. 17 to 19 shown an architrave connector block 400 which is generally a square block shape with perimeter walls 420 and a top face 410.

FIG. 17 shows an overhead view of the architrave connector block 400 having an ornamental/decorative feature 412 incorporated into the top face 410. The underside houses a recessed base 430 that is slightly higher than the perimeter walls 420, and corner pod 440.

FIG. 18 shows an end view of the architrave connector block 400 having a raised ornamental/decorative feature 412 extending from the top face 410. A recessed base 430 has a rebate shape 422 that corresponds to the architrave profile, and is housed within the perimeter walls 420 and corner pod 440.

FIG. 19 shows an isometric view of the architrave connector block 400 with clearer view of the recess 430 within the profile rebate 422. The corner pod 440 and perimeter walls 420 are defined by the architrave profile 500. The corner pod 440 also provides the cutting tolerance for the architrave.

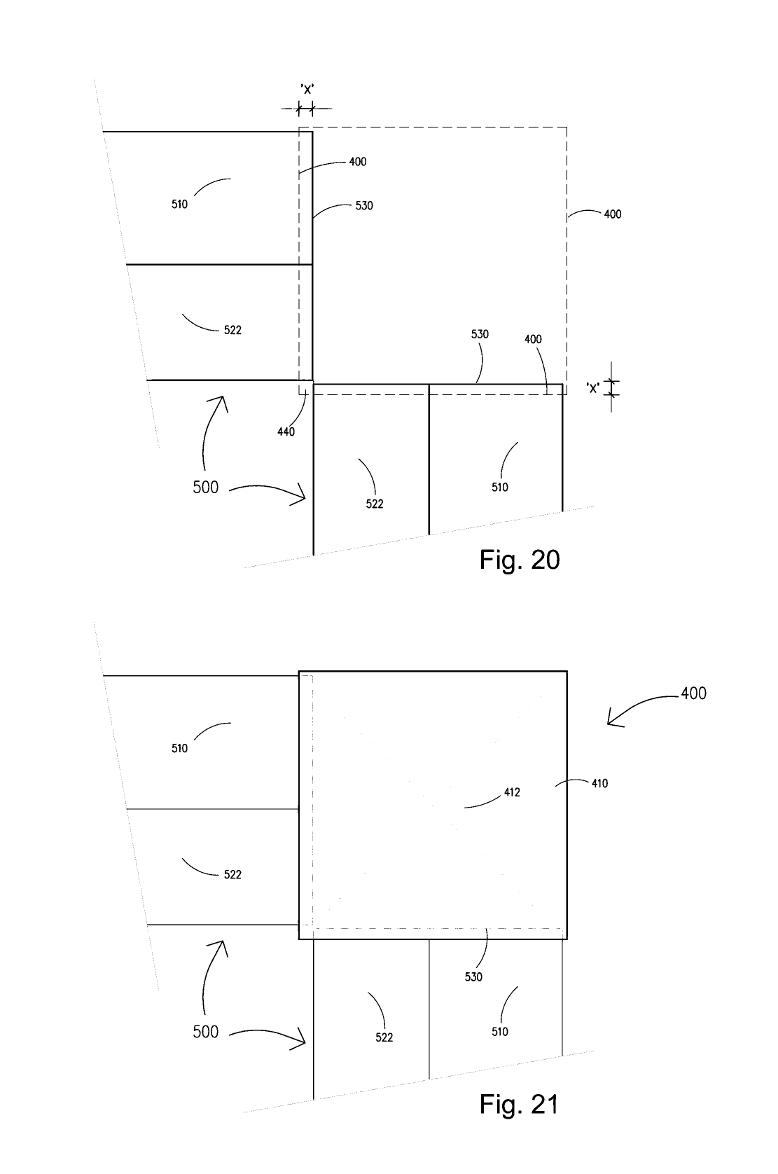

FIG. 20 shows architrave profiles 500, with front face 510 and decorative face 522 being square cut 530, with outline of architrave connector block 400 shown as a dashed line. The distance ‘X’ between the architrave square cuts 530 and connector block 400 provides the cutting tolerance.

FIG. 21 shows architrave connector block 400 fitting over the architrave profile 500, with the architrave cutting 530 being covered by the connector block 400, eliminating the need for accurate cutting.

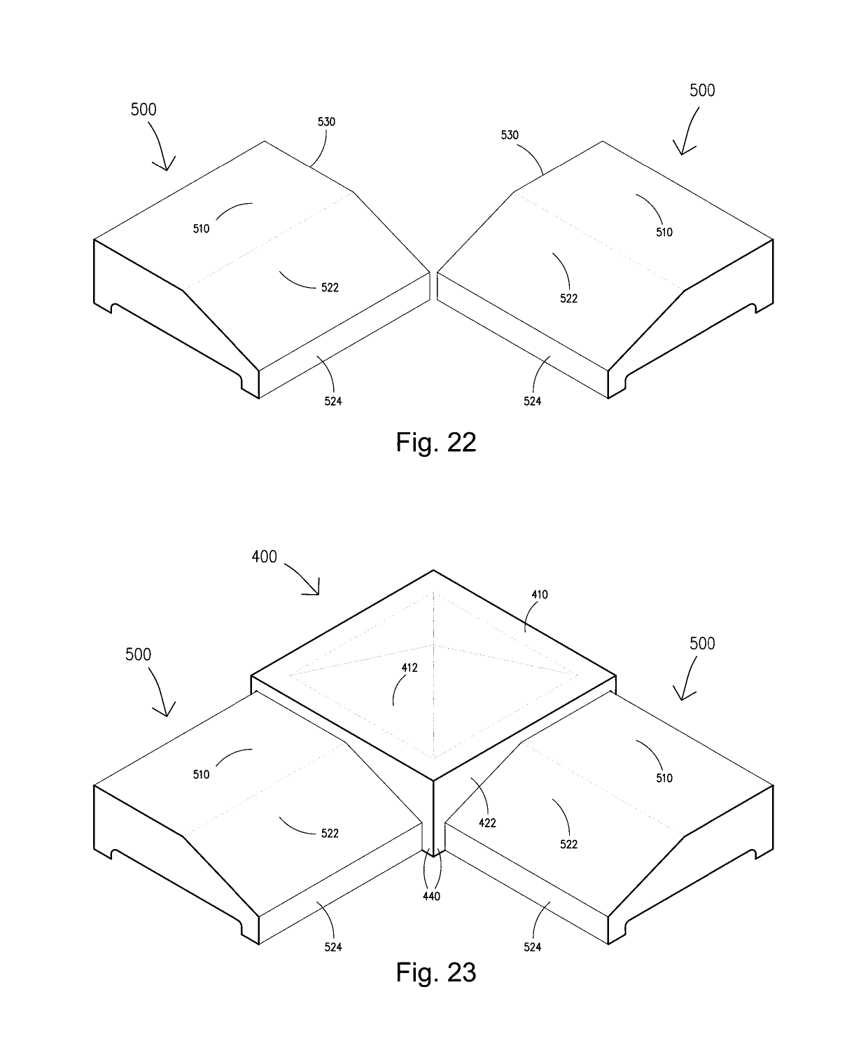

FIG. 22 is an isometric view of FIG. 20 showing the architrave profiles 500 meeting at cuts 530.

FIG. 23 is an isometric view of the connector block 400 fitted to the architrave profiles 500, with rebate 422 corresponding to the decorative profile 522. The corner pod 440 provides the cutting tolerance as the architrave profile sits within the recess.

Whilst preferred embodiments of the present invention have been described, it will be apparent to skilled persons that modifications can be made to the embodiments described.

For example, decorative feature profiles can have any desired design, differently shaped features, size or thickness. Another variation having the decorative feature profile slightly recessed, with the corresponding connector pieces compatible

The skirting rebate is large and deep in depth and provides three advantages, it allows for the corner tab to slide behind the skirting, it provides clearance for the fastener head and allows for some material flex. The rebate also provides for tolerance if the wall and door jamb/window reveals are not perfectly in alignment. The rebate extends from adjacent the top face to adjacent the bottom face of the skirting and has a depth of at least 3 mm, preferably more than 5 mm.

The side leading edges 250 with a tapering in ensures the front face is the first most point of contact with the skirting face to eliminate gap between the two components.

The preferred embodiment in one aspect provides a skirting and architrave installation system comprising:
a skirting rear profile with increased rebate,
an external corner skirting connector piece,
an internal corner skirting connector piece, and
an architrave connector block

Preferably, the rear profile rebate of the skirting is of sufficient depth to allow for space to house the inserting tab of the skirting connector pieces.

Preferably, the front surface or feature profile of the skirting can be of any ornamental design or decoration.

Preferably, the profile of the connector pieces corresponds to any ornamental design or decoration of the skirting feature profile.

Preferably, the skirting connector pieces are of a material that allows for slight deflection to conform to the angle of the corners, if the corners are not truly square.

Preferably, skirting connector pieces comprise of rear inserting tabs that lock between the skirting rear profile rebate and the building wall.

Preferably, each of the inserting tabs have a curved front surface that guides the connector piece in between the rear face of the skirting and wall.

Preferably, each of the inserting tabs is capable of flexing as the connector piece is inserted into the space between the rear of the skirting and the wall.

Preferably, the overall architrave connector block is slightly larger than the architrave profile, with an inner wall thickness that corresponds exactly to the size of the architrave profile.

Preferably, the inner wall thickness of the architrave connector block fits directly over the corresponding architrave profile for a tight connection.

Preferably, the architrave connector block houses a rebate profile that corresponds to a compatible architrave profile.

The embodiments provide a skirting and architrave installation system that uses pre-finished materials, and incorporates internal and external corner connector pieces to eliminate the need for accurate cutting and joining, thus allowing for quicker and easier installation. The top of the skirting is notched at the ends to receive the inserting tabs of the connector pieces, which are inserted from above the skirting. The inserting tabs have a curved lead that flexes between the wall and rear of skirting, providing a tight friction fit without the need for any nailing or adhesives. The outer most ends of the connector pieces have leading edges that are always in contact with the front face of the skirting profile. Architrave connector blocks incorporate a rebate to provide a cutting tolerance to the architrave profile which frame doors and windows, thus eliminating the need for tradesmen to skilfully install skirtings and architraves

The embodiments also provide a skirting and architrave installation system that comprises of:
Skirting rear profile with depth of rebate,
External corner connector piece with rear inserting tabs,
Internal corner connector piece with rear inserting tabs,
Architrave connector block with profile rebates.

Preferably, the depth of rebate at the rear face of the skirting is such to accommodate the rear inserting tab of corresponding connector piece profiles.

Preferably, the internal and external corner connector pieces are inserted from above the skirting and incorporate rear inserting tabs with a curved sector that flexes to provide a tight friction fit between the wall and the rear face of the skirting.

Preferably, the outer most ends incorporate leading edges to ensure the outer most ends always are in contact with the front face profile of the skirting profile.

The embodiments also provide a skirting and architrave installation system that incorporates rebates within the architrave connector block that correspond with the architrave profile thus providing a cutting tolerance.

The embodiments also provide a skirting and architrave installation system that allows for quicker and simpler installation by eliminating the need for skilled tradesmen to accurately measure, cut and install skirting and architraves.

Whilst preferred embodiments of the present invention have been described, it will be apparent to skilled persons that modifications can be made to the embodiments described.

The rear portion engagement means for engaging the rear surface of the skirting profile for example can comprise other shapes or other forms, such as a resilient metal or plastic clip or arm.

1. A connector piece to cover the gap between two skirting profiles disposed at an angle to each other, the connector piece comprising:
a body having a bend to correspond to the angle, the body being comprised of a front portion, a rear portion, and a cavity between the front portion and the rear portion, the cavity having end portions for receiving respective end sections of the skirting profiles, wherein the front portion forms the exposed decorative contour of the connector piece, and
wherein the rear portion comprises an engagement means for engaging a respective rear surface of the skirting profiles when the end sections of the skirting profiles are received into the cavity.

2. The connector piece of claim 1 wherein the connector piece is for a corner and the front portion comprises a substantially 90° bend therein corresponding to the corner of the wall.

3. The connector piece of claim 2 wherein the corner is an internal corner or an external corner.

4. The connector piece of claim 1 wherein the front portion matches an exposed decorative contour of the skirting profiles.

5. The connector piece of claim 1 wherein the front portion extends from the floor when mounted in use.

6. The connector piece of claim 1 wherein the engagement means of the rear portion comprises an inserting tab which extends downwardly from the front portion.

7. The connector piece of claim 6 wherein the inserting tab has a bend and follows the shape of the front portion.

8. The connector piece of claim 1 wherein the inserting tab comprises a curved lead at its lower end portion that are biased towards a rear face of the skirting profiles.

9. The connector piece of claim 1 wherein the front portion extends from the floor in use and tightly matches the exposed decorative contour of the skirting profiles.

10. The connector piece of claim 1 wherein the connector piece comprises strengthening ribs between the front portion and the rear portion.

11. The connector piece of claim 1 wherein the side extremities of the front portion are wider than the side extremities of the rear portion.

12. The connector piece of claim 1 wherein side leading edges of the front portion are splayed inwardly to contact front faces of the skirting profiles in use.

13. The connector piece of claim 1 wherein the rear portion extends to a mid-portion of the front portion.

14. The connector piece of claim 1 wherein the front portion has front face sections facing in perpendicular directions towards or away from each other.

15. A skirting profile comprising:
a front face; and
a rear face,
wherein the rear face in cross-section comprises upper and lower notches which engage a wall in use, the notches spacing the rear face from the wall providing a rebate between the rear face and the wall.

16. The skirting profile of claim 15 wherein the rebate is at least 3 mm in depth.

17. The skirting profile of claim 15 wherein the skirting profile comprises a top face and a bottom face and the rebate extends from adjacent a top face to adjacent the rear face.

18. An assembly, comprising:
two skirting profiles; and
a connector piece of claim 1.

19. An architrave connector block comprising:
a top face; and
side walls,
wherein at least two side walls comprise rebates shaped to correspond to architrave profiles.

20. The block of claim 20 comprising a raised decorative feature extending from the top face.
